(19) United States
(12) Patent Application Publication
(10) Pub. No.: US 2018/0033272 A1
(43) Pub. Date: Feb. 1, 2018

(54) MONITORING SYSTEM AND MONITORING METHOD

(71) Applicants: Mitsui Fudosan Co., Ltd, Tokyo (JP); CREW SYSTEMS, INC., Tokyo (JP)

(72) Inventor: Katsuhiko HIRAYAMA, Tokyo (JP)

(73) Assignees: Mitsui Fudosan Co., Ltd, Tokyo (JP); CREW SYSTEMS, INC., Tokyo (JP)

(21) Appl. No.: 15/500,670

(22) PCT Filed: Feb. 4, 2016
(86) PCT No.: PCT/JP2016/053364

§ 371 Date: Jan. 31, 2017

(51) Int. Cl. G08B 13/196; H04N 5/91

(52) U.S. Cl. CPC G08B 13/19669; G08B 13/19656; H04N 5/91

(57) ABSTRACT

To achieve an object of reducing a burden of running costs such as communication cost and management cost for recorded data of a monitoring site as much as possible, according to an embodiment, there is provided a monitoring system including: an imaging apparatus configured to acquire the recorded data of the monitoring site; an information processing apparatus configured to control recording of the recorded data; and an external storage apparatus configured to store the recorded data. The imaging apparatus transmits verification data to the information processing apparatus, the verification data being obtained by extracting, out of the recorded data, the profile, the evaluation value, the value detected by the first sensor, and the value detected by the second sensor. The information processing apparatus transmits, to the imaging apparatus, an instruction to transmit the recorded data based on the profile when an abnormality in the monitoring site is detected.

### TECHNICAL FIELD

The present invention relates to a monitoring system and a monitoring method.

### BACKGROUND ART

Hitherto, monitoring service is run based on recorded data items of a monitoring target, which are acquired by a plurality of imaging apparatus. For example, Patent Literature 1 discloses a technology for facilitating detection of a moving body from the recorded data items acquired by the plurality of imaging apparatus.

Further, in recent years, data management such as software updates and file backup has not been carried out separately in information processing apparatus, and there has been utilized a technology of carrying out the data management in the information processing apparatus communicably with each other via a network. In the field of the monitoring service, data centers have started to utilize such a technology so as to carry out management of the image data items of the monitoring target.

### CITATION LIST

### Patent Literature

[PTL 1] Japanese Patent Application Laid-open No. 2006-067139

### SUMMARY OF INVENTION

### Technical Problem

The monitoring service involves continuous imaging of the monitoring site with the plurality of imaging apparatus. Thus, during the monitoring service, an enormous number of recorded data items are generated. Thus, when the data centers manage the recorded data items for the monitoring service, there is a problem in that a burden of running costs such as communication cost for transmitting the recorded data items of the monitoring target, and management cost for the management of the recorded data items is increased.

The present invention, which has been made in view of such circumstances, has an object of providing a monitoring system and a monitoring method that reduce a burden of running costs such as communication cost and management cost for recorded data items of a monitoring site as much as possible.

### Solution to Problem

In order to solve the problems as described above and to achieve the above-mentioned object, according to an embodiment of the present application, there is provided a monitoring system including:
an imaging apparatus configured to acquire a recorded data item of a monitoring site;
an information processing apparatus configured to control recording of the recorded data item; and
an external storage apparatus configured to store the recorded data item,
the imaging apparatus including:
   a first sensor and a second sensor each configured to detect a non-physical quantity in the monitoring site;
   a calculation unit configured to calculate, through comparison between data sizes of frames of the recorded data item, an evaluation value corresponding to variation between the data sizes;
   a data storing unit configured to correlate to each other
      the recorded data item,
      a profile of the recorded data item,
      the evaluation value corresponding to the recorded data item,
      a value detected by the first sensor and corresponding to the recorded data item, and
      a value detected by the second sensor and corresponding to the recorded data item,
   the data storing unit being configured to cause the recorded data item, the profile, the evaluation value, the value detected by the first sensor, and the value detected by the second sensor to be stored into a storage unit;
   a verification-data transmission unit configured to transmit a verification data item to the information processing apparatus, the verification data item being obtained by extracting, out of the recorded data item, the profile, the evaluation value, the value detected by the first sensor, and the value detected by the second sensor; and
   a recorded-data transmission unit configured to acquire, when an instruction to transmit the recorded data item is received from the information processing apparatus, the recorded data item from the storage unit based on the profile contained in the instruction to transmit the recorded data item,
   the recorded-data transmission unit being configured to transmit the acquired recorded data item to the information processing apparatus,
the information processing apparatus including:
   an event detection unit configured to execute detection of an abnormality in the monitoring site based on
      a result of comparison between the evaluation value contained in the verification data item received from the imaging apparatus and a threshold,
      a result of comparison between the value detected by the first sensor and a threshold, the value detected by the first sensor being contained in the verification data item, and
      a result of comparison between the value detected by the second sensor and a threshold, the value detected by the second sensor being contained in the verification data item; and
   a recorded-data storing unit configured to cause the recorded data item received from the imaging apparatus to be stored into the external storage apparatus,
the event detection unit being configured to transmit, to the imaging apparatus, the instruction to transmit the recorded data item based on the profile when the abnormality in the monitoring site is detected.

In order to solve the problems as described above and to achieve the above-mentioned object, according to another embodiment of the present application, there is provided a monitoring method that is executed by a monitoring system including:
an imaging apparatus configured to acquire a recorded data item of a monitoring site;
an information processing apparatus configured to control recording of the recorded data item; and
an external storage apparatus configured to store the recorded data item,
the monitoring method including causing the imaging apparatus to carry out:
   a step of detecting a non-physical quantity in the monitoring site;
   a step of calculating, through comparison between data sizes of frames of the recorded data item, an evaluation value corresponding to variation between the data sizes;
   a step of correlating to each other
      the recorded data item,
      a profile of the recorded data item,
      the evaluation value corresponding to the recorded data item,
      a value detected by the first sensor and corresponding to the recorded data item, and
      a value detected by the second sensor and corresponding to the recorded data item,
   and of causing the recorded data item, the profile, the evaluation value, the value detected by the first sensor, and the value detected by the second sensor to be stored into a storage unit;
   a step of transmitting a verification data item to the information processing apparatus, the verification data item being obtained by extracting, out of the recorded data item, the profile, the evaluation value, the value detected by the first sensor, and the value detected by the second sensor; and
   a step of acquiring, when an instruction to transmit the recorded data item is received from the information processing apparatus, the recorded data item from the storage unit based on the profile contained in the instruction to transmit the recorded data item,
   and of transmitting the acquired recorded data item to the information processing apparatus,
the monitoring method including causing the information processing apparatus to carry out:
   a step of executing detection of an abnormality in the monitoring site based on
      a result of comparison between the evaluation value contained in the verification data item received from the imaging apparatus and a threshold,
      a result of comparison between the value detected by the first sensor and a threshold, the value detected by the first sensor being contained in the verification data item, and
      a result of comparison between the value detected by the second sensor and a threshold, the value detected by the second sensor being contained in the verification data item;
   a step of transmitting, to the imaging apparatus, the instruction to transmit the recorded data item based on the profile when the abnormality in the monitoring site is detected; and
   a step of causing the recorded data item received from the imaging apparatus to be stored into the external storage apparatus.

### Advantageous Effects of Invention

The monitoring system and the monitoring method according to the present application provide an advantage of reducing a burden of running costs such as communication cost and management cost for recorded data items of a monitoring site as much as possible.

### BRIEF DESCRIPTION OF DRAWINGS

FIG. 1 is a diagram showing a schematic configuration of a monitoring system.

FIG. 2 is a block diagram showing a functional configuration of an imaging apparatus.

FIG. 3 is a diagram showing an example of a file structure of a recorded data item.

FIG. 4 is a diagram showing an example of a file structure of a verification data item.

FIG. 5 is a diagram showing an example of a file structure of a recorded data item in case of an emergency.

FIG. 6 is a block diagram showing functional configurations of an information processing apparatus and an external storage apparatus.

FIG. 7 is a flowchart showing a flow of a scene-transition-amount calculation process according to a first embodiment.

FIG. 8 is a flowchart showing a flow of an event detection process according to the first embodiment.

FIG. 9 is another flowchart showing the flow of the event detection process according to the first embodiment.

FIG. 10 is a flowchart showing a flow of an offset-value update process according to the first embodiment.

FIG. 11 is a flowchart showing a flow of an event detection process according to a second embodiment.

FIG. 12 is a table showing an example of determination results of the event detection process according to the second embodiment.

### DESCRIPTION OF EMBODIMENTS

Below, monitoring systems and monitoring methods according to embodiments of the present application are described in detail with reference to the drawings. The monitoring systems and the monitoring methods according to the present application are not limited by the embodiments described below. Matters described in the following embodiments encompass what is called equivalents such as matters that can be easily conceived by those skilled in the art, and substantially the same matters. The matters described in the following embodiments are applied to processes regarding recorded data items of a monitoring target, which is acquired from imaging apparatus installed, for example, in office buildings, business parks, shopping malls, fashion malls, parks, amusement facilities, high-tech parks, and residential facilities.

### First Embodiment

[Configuration of System]

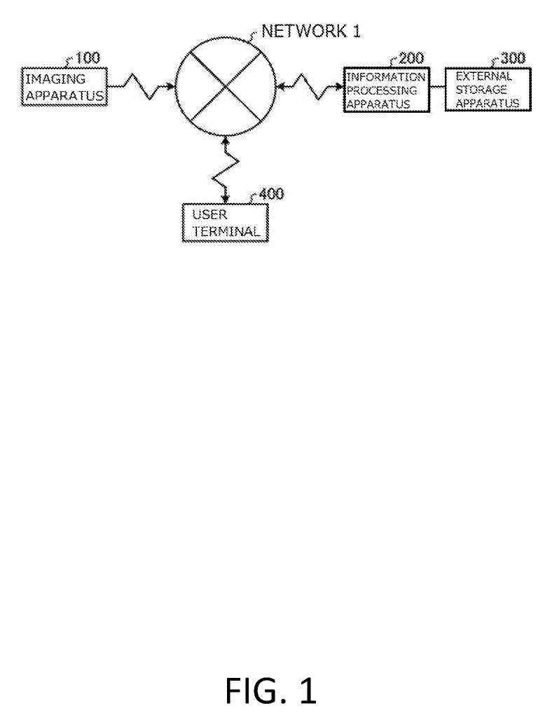

FIG. 1 is a diagram showing a schematic configuration of a monitoring system. As shown in FIG. 1, the monitoring systems according to the following embodiments include an imaging apparatus 100, an information processing apparatus 200, an external storage apparatus 300, and a user terminal 400. The imaging apparatus 100, the information processing apparatus 200, and the user terminal 400 are communicably connected to each other via a network 1. The imaging apparatus 100 is an apparatus that acquires recorded data items of a monitoring site, such as a digital camera that records the recorded data items as digital data items. The information processing apparatus 200 is an apparatus such as a server, which controls recording of the recorded data items acquired by the imaging apparatus 100. The external storage apparatus 300 is an apparatus that stores the recorded data items acquired by the imaging apparatus 100. The user terminal 400 is a terminal that is used by a user. Examples of the network 1 include a public telephone network, the Internet, and a carrier network. The network 1 is capable of transmitting and receiving data items by using a predetermined communication protocol via network communication devices such as a hub, a router, a bridge, and a proxy server.

[Configuration of Imaging Apparatus]

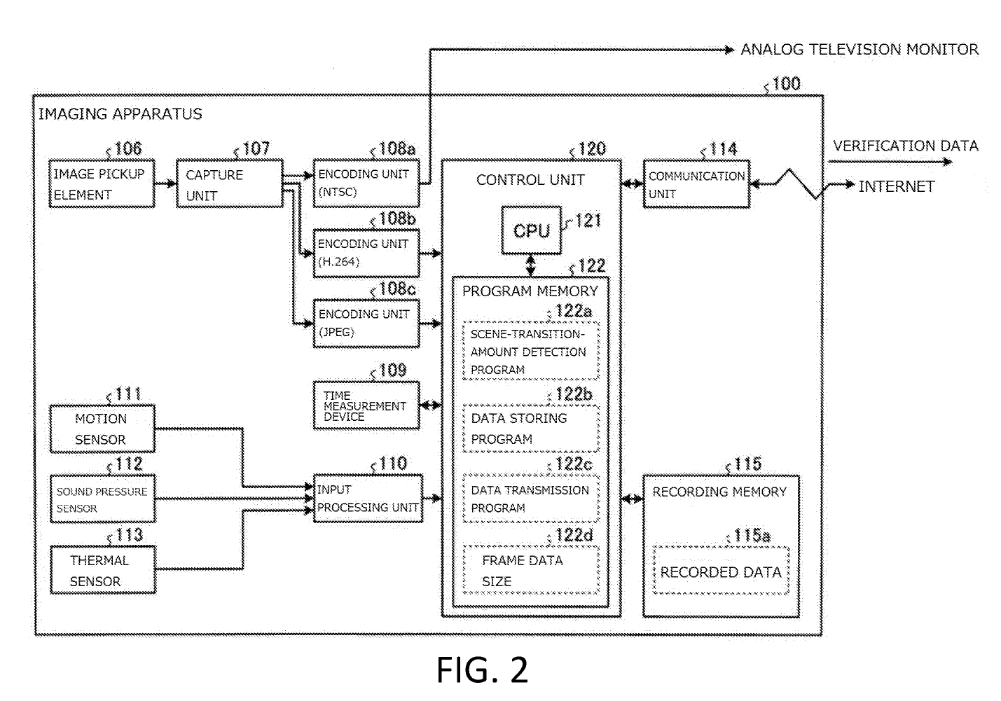

FIG. 2 is a block diagram showing a functional configuration of the imaging apparatus 100. As shown in FIG. 2, the imaging apparatus 100 includes an image pickup element 106, a capture unit 107, encoding units 108a to 108c, a time measurement device 109, an input processing unit 110, a motion sensor 111, a sound pressure sensor 112, a thermal sensor 113, a communication unit 114, a recording memory 115, and a control unit 120.

The image pickup element 106 converts received light to electrical signals. Examples of the image pickup element 106 include image sensors using, for example, a complementary metal-oxide semiconductor (CMOS), a MOS, and a charge-coupled device (CCD).

The capture unit 107 processes the electrical signals generated by the image pickup element 106. With this, the electrical signals are synthesized into digital images in frame units.

The encoding units 108a to 108c convert a format of the digital images synthesized by the capture unit 107 into respective formats. The encoding unit 108a converts the format of the digital images synthesized by the capture unit 107 to a national television standards committee (NTSC) format being a standard format of terrestrial analog television broadcast. The encoding unit 108a transmits data items after the format conversion to an analog television monitor. The encoding unit 108b converts the format of the digital images synthesized by the capture unit 107 to an H.264 format being a format of compression-coding of moving-image data items. The encoding unit 108b transmits data items after the format conversion to the control unit 120. The encoding unit 108c converts the format of the digital images synthesized by the capture unit 107 to a joint photograph experts group (JPEG) format being a compression format of still-image data items. The encoding unit 108c transmits the data items after the format conversion to the control unit 120. The above-mentioned formats used in the conversion by the encoding units 108a to 108c are merely examples, and formats other than the above-mentioned ones may be applied.

The time measurement device 109 measures time. The time measurement device 109 transmits data items of the measured time to the control unit 120.

The input processing unit 110 transmits measurement values measured by the motion sensor 111, the sound pressure sensor 112, and the thermal sensor 113 to the control unit 120. The motion sensor 111 detects presence of a person in the monitoring site based, for example, on infrared light, visible light, and ultrasonic waves. The motion sensor 111 transmits the number of detection times of the presence of the person (number of responses of the sensor) to the input processing unit 110. The sound pressure sensor 112 detects sound pressure in the monitoring site. The sound pressure sensor 112 transmits the number of detection times of the sound pressure at a predetermined level or higher in the monitoring site (number of responses of the sensor) to the input processing unit 110. The thermal sensor 113 detects abnormal high-temperature conditions in case, for example, of fire in the monitoring site. When a temperature at the monitoring site exceeds a certain temperature, the thermal sensor 113 transmits a corresponding signal to the input processing unit 110. The motion sensor 111 and the sound pressure sensor 112 are examples of a first sensor and a second sensor.

The communication unit 114 transmits and receives various data items to be exchanged between the communication unit 114 and the information processing apparatus 200. The communication unit 114 communicates in a wired or wireless manner via the predetermined communication protocol.

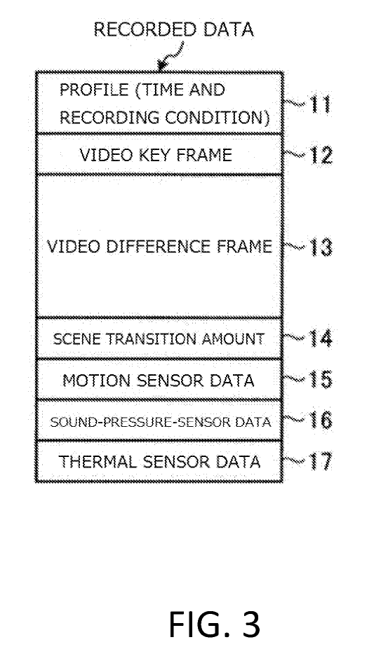

The recording memory 115 stores a recorded data item 115a of the monitoring site, which is acquired by the imaging apparatus 100. Examples of the recording memory 115 include nonvolatile memories such as a flash memory (storage medium capable of only readout, such as a CD-ROM), volatile memories such as a random access memory (RAM), or combinations thereof. The recorded data item 115a is stored under a state in which the recorded data item of the monitoring site, a profile of the recorded data item, and the values detected by the motion sensor 111 and the sound pressure sensor 112, which correspond to the recorded data item, are integrated with each other on the basis of the time. FIG. 3 is a diagram showing an example of a file structure of the recorded data item. As shown in FIG. 3, the recorded data item 115a is obtained in a form of a single file in which data items, that is, a profile (time and recording condition) 11, a video KEY frame 12, video difference frames 13, a scene transition amount 14, a motion-sensor data item 15, a sound-pressure-sensor data item 16, and a thermal-sensor data item 17 are synchronized with each other on the basis of the time measured by the time measurement device 109.

The profile 11 contains data items of an installation site of the imaging apparatus 100, and of the time measured by the time measurement device 109, and a data item of the recording condition that is set by an administrator of the imaging apparatus 100. The video KEY frame 12 is obtained from the data items after the format conversion by the encoding unit 108c. The video difference frames 13 are obtained from the data items after the format conversion by the encoding unit 108b. The scene transition amount 14 is obtained from data items based on results of processes by the control unit 120 described below. The motion-sensor data item 15 is obtained from the value detected by the motion sensor 111. The sound-pressure-sensor data item 16 is obtained from the value detected by the sound pressure sensor 112. The thermal-sensor data item 17 is obtained from a data item based on the detection result from the thermal sensor 113.

The control unit 120 includes hardware resources such as a central processing unit (CPU) 121 being an arithmetic device, and a program memory 122 being a storage device. With use of those hardware resources, the control unit 120 executes programs stored in the program memory 122. In this way, the various processes are executed. Examples of the arithmetic processing apparatus may include a system-on-a-chip (SoC), a micro control unit (MCU), a field-programmable gate array (FPGA), and a coprocessor, but are not limited thereto.

The program memory 122 stores data items and the programs that are necessary for the various processes to be executed by the control unit 120. Examples of the program memory 122 include nonvolatile memories such as a flash memory, volatile memories such as a random access memory (RAM), or combinations thereof. The program memory 122 functions also as a working memory at the time when the control unit 120 executes the various programs. A working memory other than the program memory 122 may be installed. As one of the data items necessary for the various processes to be executed by the control unit 120, the program memory 122 stores data sizes of the video difference frames 13, specifically, a frame data size 122d being a latest data size.

As shown in FIG. 2, the program memory 122 stores a scene-transition-amount detection program 122a, a data storing program 122b, a data transmission program 122c, and the frame data size 122d. In accordance with the scene-transition-amount detection program 122a, processes regarding the digital images to be synthesized by the capture unit 107 are successively executed. In accordance with the data storing program 122b and the data transmission program 122c, in units of a predetermined time period (for example, every 1 minute), the data items regarding the digital images to be synthesized by the capture unit 107 are processed and integrated with each other into the single file having a predetermined file structure. The units of the time period for integrating the digital images may be arbitrarily changed.

The scene-transition-amount detection program 122a provides a function to calculate a value of the scene transition amount 14 corresponding to variation between the data sizes through comparison between the data sizes of the frames of the recorded data item. Specifically, by execution of the scene-transition-amount detection program 122a, the following processes are carried out. A latest video difference frame 13 is acquired, a data size of a previously-received video difference frame 13 is acquired from the program memory 122, and a difference between data sizes of the current frame and the previous frame is calculated. When the calculated difference exceeds a threshold, the value of the scene transition amount is incremented (+1), and the data size of the previous frame is overwritten by the data size of the current frame. When the calculated difference does not exceed the threshold, the data size of the previous frame is overwritten by the data size of the current frame without incrementing the value of the scene transition amount. The scene-transition-amount detection program 122a is an example of a calculation unit. The value of the scene transition amount calculated by the scene-transition-amount detection program 122a is an example of an evaluation value.

The data storing program 122b provides a function to correlate and integrate the data items of the profile 11, the video KEY frame 12, the video difference frames 13, the scene transition amount 14, the motion-sensor data item 15, the sound-pressure-sensor data item 16, and the thermal-sensor data item 17 with each other into the recorded data item 115a being the single file, and to cause the recorded data item 115a to be stored into the recording memory 115. Specifically, by execution of the data storing program 122b, the following processes are carried out. The video difference KEY frame 12 and the video difference frames 13 are acquired. The profile is generated based, for example, on the time measured by the time measurement device 109 and on the preset recording condition. Within the predetermined time period (for example, 1 minute) after acquisition of a first video difference frame 13, the video KEY frame 12, the video difference frames 13, the motion-sensor data item 15, the sound-pressure-sensor data item 16, and the thermal-sensor data item 17 are gathered. Within the predetermined time period (for example, 1 minute) after the acquisition of the first video difference frame 13, the data items of the scene transition amount 14 calculated by the scene-transition-amount detection program 122a are gathered. Within the predetermined time period (for example, 1 minute) after the acquisition of the first video difference frame 13, the video KEY frame 12, the video difference frames 13, the scene transition amount 14, the motion-sensor data item 15, the sound-pressure-sensor data item 16, and the thermal-sensor data item 17 are gathered as data items to be synchronized, and are integrated into the single file. The single file is stored into the recording memory 115. After those data items are stored, whenever the video difference KEY frame 12 and the video difference frames 13 are acquired, the above-described processes are executed. In the case where the above-mentioned data items being the data items to be synchronized are integrated into the single file, marks such as sequence numbers or flags corresponding to the video difference frames 13 may be added to the data items such that the integration may be performed based on those marks. The data storing program 122b is an example of a data storing unit.

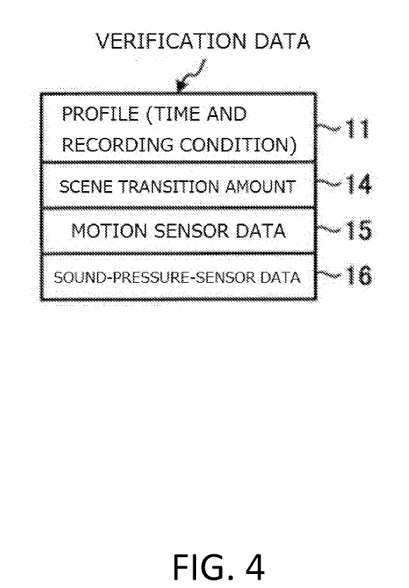

The data transmission program 122c provides a function to transmit, as a verification data item, the data items, that is, the profile 11, the scene transition amount 14, the motion-sensor data item 15, and the sound-pressure-sensor data item 16 out of the recorded data item 115a to the information processing apparatus 200. Specifically, by execution of the data transmission program 122c, the following processes are carried out. The data items, that is, the profile 11, the scene transition amount 14, the motion-sensor data item 15, and the sound-pressure-sensor data item 16 are extracted out of the recorded data item 115a. Those extracted data items are transmitted as the verification data item to the information processing apparatus 200 via the communication unit 114. FIG. 4 is a diagram showing an example of a file structure of the verification data item. As shown in FIG. 4, the file structure of the verification data item is a single file containing the data items, that is, the profile (time and recording condition) 11, the scene transition amount 14, the motion-sensor data item 15, and the sound-pressure-sensor data item 16 out of the recorded data item 115a. The data transmission program 122c is an example of a data transmission unit.

Further, the data transmission program 122c provides a function to acquire the recorded data item 115a from the recording memory 115 based on the profile 11 contained in an instruction to transmit the recorded data item 115a when the instruction is received from the information processing apparatus 200, and to transmit the acquired recorded data item 115a to the information processing apparatus 200. Specifically, by execution of the data transmission program 122c, the following processes are carried out. Based on the profile 11 (such as time and installation site) contained in the transmission instruction, an identical recorded data item having the same profile 11 containing the same data items is acquired from among the recorded data items stored in the recording memory 115. The acquired recorded data item is transmitted to the information processing apparatus 200. Note that, all the data items contained in the file of the recorded data item 115a are transmitted to the information processing apparatus 200. The data transmission program 122c is an example of a recorded-data transmission unit.

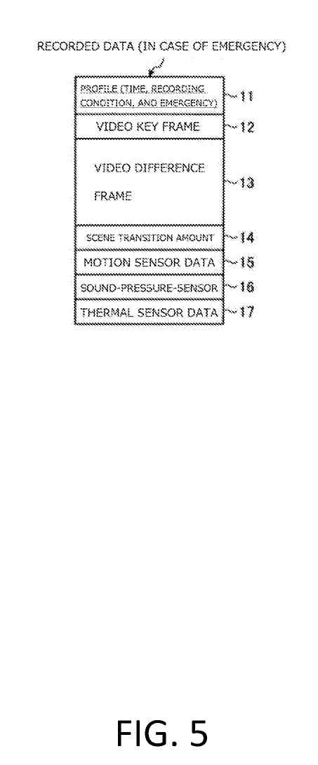

Further, the data transmission program 122c provides a function to automatically transmit the recorded data item 115a to the information processing apparatus 200 even when the instruction to transmit the recorded data item 115a is not received from the information processing apparatus 200 in case where it is determined that the monitoring site has been in the abnormal high-temperature condition in response to the signal transmitted from the thermal sensor 113. FIG. 5 is a diagram showing an example of a file structure of a recorded data item in case of an emergency. As shown in FIG. 5, this file structure is basically the same as the file structure of the recorded data item shown in FIG. 3 except that a data item indicating the emergency is inserted into the profile 11.

As long as the file structure of the recorded data item to be transmitted to the information processing apparatus 200 can be processed in the information processing apparatus 200, this file structure may be the same as the file structure of the recorded data item 115a. When the file structure of the recorded data item to be transmitted to the information processing apparatus 200 cannot be processed in the information processing apparatus 200, this file structure may be changed in accordance with the data transmission program 122c to a structure that can be processed in the information processing apparatus 200.

[Configuration of Information Processing Apparatus]

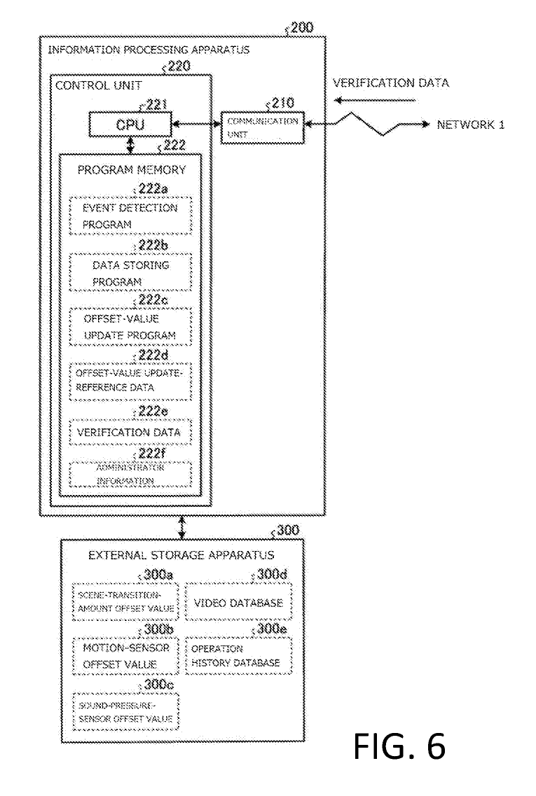

FIG. 6 is a block diagram showing functional configurations of the information processing apparatus 200 and the external storage apparatus 300.

The external storage apparatus 300 shown in FIG. 6 stores a scene-transition-amount offset value 300a, a motion-sensor offset value 300b, a sound-pressure-sensor offset value 300c, a video database 300d, and an operation history database 300e.

The scene-transition-amount offset value 300a, the motion-sensor offset value 300b, and the sound-pressure-sensor offset value 300c are used in the processes in the information processing apparatus 200. The scene-transition-amount offset value 300a, the motion-sensor offset value 300b, and the sound-pressure-sensor offset value 300c are updated by the information processing apparatus 200 in accordance with the installation site of the imaging apparatus 100 and a time zone. At a stage before start of the processes in the information processing apparatus 200, the scene-transition-amount offset value 300a, the motion-sensor offset value 300b, and the sound-pressure-sensor offset value 300c are each set to a predetermined default value.

The video database 300d is a database that records the recorded data item 115a of the monitoring site, which is received from the imaging apparatus 100. The operation history database 300e stores histories (logs) of access to the external storage apparatus 300 by the administrator of the information processing apparatus 200 and the external storage apparatus 300. The histories (logs) of the access are utilized at the time of, for example, detection of illegal access to the external storage apparatus 300.

The information processing apparatus 200 shown in FIG. 6 includes a communication unit 210 and a control unit 220.

The communication unit 210 transmits and receives various data items to be exchanged between the communication unit 210 and the imaging apparatus 100, the external storage apparatus 300, and the user terminal 400. The communication unit 210 communicates in a wired or wireless manner via the predetermined communication protocol.

The control unit 220 includes hardware resources such as a central processing unit (CPU) 221 being an arithmetic device, and a program memory 222 being a storage device. With use of those hardware resources, the control unit 220 executes programs stored in the program memory 222. In this way, the various processes are executed. Examples of the arithmetic processing apparatus may include a system-on-a-chip (SoC), a micro control unit (MCU), a field-programmable gate array (FPGA), and a coprocessor, but are not limited thereto.

The program memory 222 stores the data items and the programs that are necessary for the various processes to be executed by the control unit 220. Examples of the program memory 222 include nonvolatile memories such as a flash memory, volatile memories such as a random access memory (RAM), or combinations thereof. The program memory 222 functions also as a working memory at the time when the control unit 220 executes the various programs. As one of the data items necessary for the various processes to be executed by the control unit 220, the program memory 222 stores, for example, verification data items 222e received from the imaging apparatus 100.

As shown in FIG. 6, the program memory 222 stores an event detection program 222a, a data storing program 222b, an offset-value update program 222c, an offset-value update-reference data item 222d, the verification data item 222e, and an administrator information item 222f.

The event detection program 222a provides a function to execute a process of detecting an abnormality (event) in the monitoring site based on a result of comparison between the value of the scene transition amount 14 contained in the verification data item 222e received from the imaging apparatus 100 and a threshold, based on a result of comparison between the value of the motion-sensor data item 15 contained in the verification data item 222e and a threshold, and based on a result of comparison between the value of the sound-pressure-sensor data item 16 contained in the verification data item 222e and a threshold. The event detection program 222a is an example of an event detection unit.

Specifically, by execution of the event detection program 222a, the following processes are carried out. When the verification data item 222e is received, the scene-transition-amount off set value 300a is acquired from the external storage apparatus 300, and the scene-transition-amount offset value 300a is subtracted from the value of the scene transition amount contained in the verification data item. A determination as to whether a value of the scene transition amount as a result of the subtraction of the scene-transition-amount offset value 300a is 1 or more is made. When a determination that this value is 1 or more is made, an email is sent to the registered administrator (user terminal 400). Subsequently, the instruction to transmit the recorded data item corresponding to the received verification data item 222e is transmitted to the imaging apparatus 100. Meanwhile, when the value of the scene transition amount as a result of the subtraction of the scene-transition-amount offset value 300a is not 1 or more, the motion-sensor offset value 300b is acquired from the external storage apparatus 300, and the motion-sensor offset value 300b is subtracted from the value of the motion-sensor data item 15 contained in the verification data item 222e. A determination as to whether a value of the motion-sensor data item 15 as a result of the subtraction of the motion-sensor offset value 300b is 1 or more is made. When a determination that this value is 1 or more is made, an email is sent to the registered administrator (user terminal 400). Subsequently, the instruction to transmit the recorded data item corresponding to the received verification data item 222e is transmitted to the imaging apparatus 100. Meanwhile, when the value of the motion-sensor data item 15 as a result of the subtraction of the motion-sensor offset value 300b is not 1 or more, the sound-pressure-sensor offset value 300c is acquired from the external storage apparatus 300, and the sound-pressure-sensor offset value 300c is subtracted from the value of the sound-pressure-sensor data item 16 contained in the verification data item 222e. A determination as to whether a value of the sound-pressure-sensor data item 16 as a result of the subtraction of the sound-pressure-sensor offset value 300c is 1 or more is made. When a determination that this value is 1 or more is made, an email is sent to the registered administrator (user terminal 400). Subsequently, the instruction to transmit the recorded data item corresponding to the received verification data item 222e is transmitted to the imaging apparatus 100. Meanwhile, when the value of the sound-pressure-sensor data item 16 as a result of the subtraction of the sound-pressure-sensor offset value 300c is not 1 or more, the processes regarding the corresponding verification data item 222e is ended. The above-mentioned transmission instruction contains the profile 11 contained in the verification data item 222e. In the imaging apparatus 100, based on the information items (such as time and installation site) of the profile 11 contained in the transmission instruction, the recorded data item 115a corresponding to the transmission instruction is searched for.

The data storing program 222b provides a function to execute a process of causing the recorded data item 115a received from the imaging apparatus 100 to be stored into the external storage apparatus 300. Specifically, by execution of the data storing program 222b, the following processes are carried out. When the instruction to transmit the recorded data item 115a is transmitted to the imaging apparatus 100 in accordance with the event detection program 222a, and then the recorded data item 115a of a corresponding time (time contained in the profile 11 of the verification data item 222e) is received, this received recorded data item is stored into the external storage apparatus 300. Further, when the recorded data item 115a in case of an emergency is received from the imaging apparatus 100, this received recorded data item is stored into the external storage apparatus 300. The data storing program 222b is an example of a recorded-data storing unit.

The offset-value update program 222c provides a function to execute a process of updating the scene-transition-amount offset value 300a, the motion-sensor offset value 300b, and the sound-pressure-sensor offset value 300c based on the offset-value update-reference data item 222d. Specifically, by execution of the offset-value update program 222c, the following processes are carried out. When the updates of the offset values are determined, the default values of the scene-transition-amount offset value 300a, the motion-sensor offset value 300b, and the sound-pressure-sensor offset value 300c are acquired from the external storage apparatus 300. From the offset-value update-reference data item 222d, an adjustment value corresponding to the installation site and the time that are contained in the profile 11 of the verification data item 222e is acquired. Values obtained by multiplying respective default values of the scene transition amount, the motion sensor, and the sound pressure sensor by the corresponding adjustment value are set as offset values in the corresponding time zone. In this way, the offset values are updated. The default values of the offset values are each calculated in advance from a sum of average values of a non-physical quantity contained in the verification data item 222e. The value of the scene transition amount, the value detected by the motion sensor, and the value detected by the sound pressure sensor are examples of the non-physical quantity. For example, an offset value of a scene transition amount corresponding to 12 o'clock is calculated by multiplying a sum of average values of scene transition amounts in 30 minutes around 12 o'clock by the adjustment value corresponding to the installation site of the imaging apparatus 100 and the time zone. The offset value of the motion sensor and the offset value of the sound pressure sensor are calculated in the same way as that of updating the offset value of the scene transition amount as described above.

The offset-value update-reference data item 222d is used in the processes for updating the offset values in accordance with the offset-value update program 222c. For example, the adjustment value (magnification) corresponding to the installation site of the imaging apparatus 100 and the time zone is set as the offset-value update-reference data item 222d. Specifically, the adjustment value is set to from 3 to 5 for a time zone of from 11 o'clock to 16 o'clock in a commercial building, and set to 2 for a time zone of from 18 o'clock to 24 o'clock in the commercial building. The adjustment value that is used at the time of calculating the scene-transition-amount offset value 300a, the motion-sensor offset value 300b, and the sound-pressure-sensor offset value 300c need not necessarily be changed in accordance with the types of the data items, or may be changed in accordance with the types of the data items.

The verification data items 222e are data items that are transmitted at predetermined time intervals from the imaging apparatus 100. The verification data items 222e may be deleted one by one from the program memory 222 whenever the processes in accordance with the event detection program 222a are completed, or may collectively be deleted at once.

The administrator information item 222f contains an information item of an email address of the user terminal 400 that is notified of occurrence of the abnormality (event) in the monitoring site.

### Processes According to First Embodiment

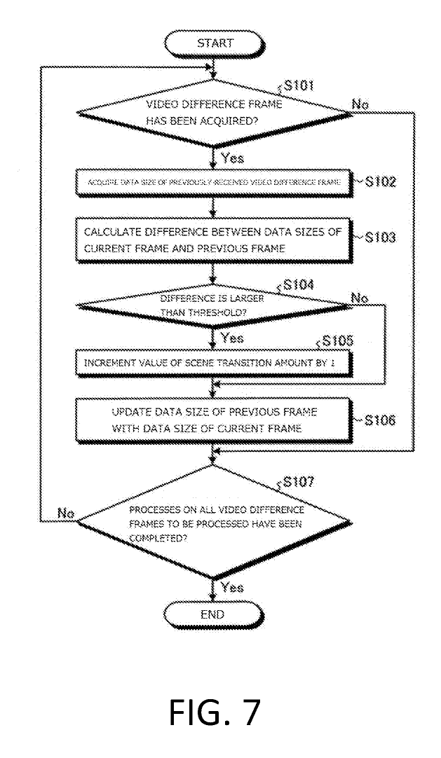

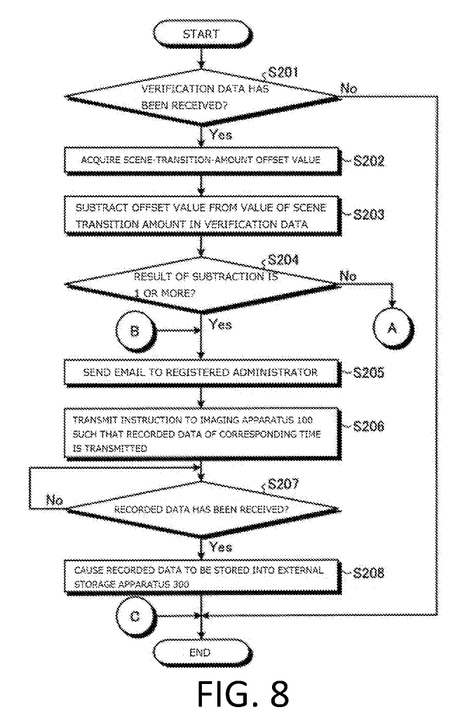

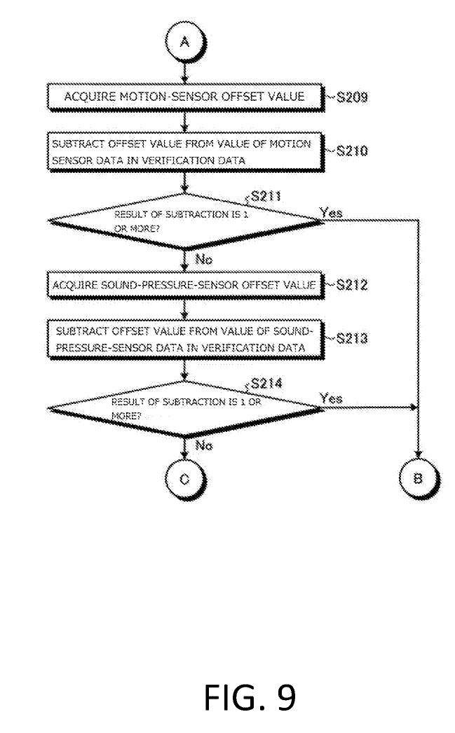

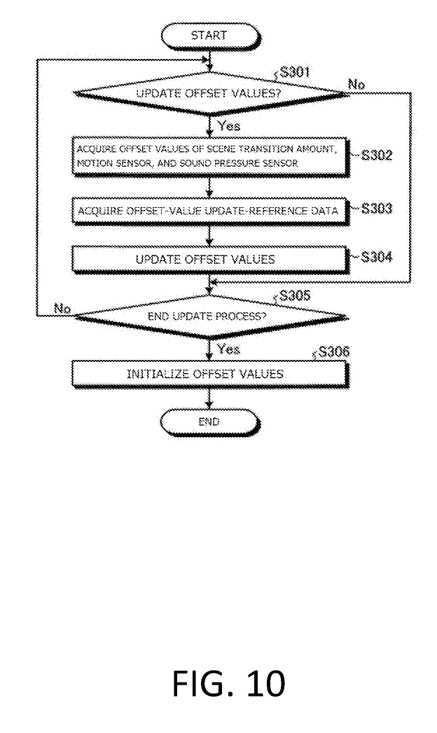

With reference to FIG. 7 to FIG. 10, flows of the processes according to the first embodiment are described. FIG. 7 is a flowchart showing a flow of the scene-transition-amount calculation process according to the first embodiment. FIG. 8 and FIG. 9 are flowcharts showing a flow of the event detection process according to the first embodiment. FIG. 10 is a flowchart showing a flow of the offset-value update process according to the first embodiment.

[Scene-Transition-Amount Calculation Process]

First, with reference to FIG. 7, the flow of the scene-transition-amount calculation process that is executed in the imaging apparatus 100 is described. The scene-transition-amount calculation process shown in FIG. 7 is carried out when the CPU 121 executes the scene-transition-amount detection program 122a.

As shown in FIG. 7, the imaging apparatus 100 determines whether a latest video difference frame 13 has been acquired (Step S101). When a determined result that the latest video difference frame 13 has been acquired is obtained (Yes in Step S101), the imaging apparatus 100 acquires a data size of a previously-received video difference frame 13 from the working memory 122 (Step S102).

Then, the imaging apparatus 100 calculates a difference between the data size of the latest video difference frame 13 (current frame) acquired in Step S101, and the data size of the previous frame acquired in Step S102 (Step S103).

Next, the imaging apparatus 100 determines whether the difference calculated in Step S103 has exceeded a threshold (Step S104).

When a determination result that the difference calculated in Step S103 has exceeded the threshold is obtained (Yes in Step S104), the imaging apparatus 100 increments (+1) a value of the scene transition amount 14 (Step S105). Then, the imaging apparatus 100 updates the data size of the previous frame with the data size of the current frame (Step S106).

In Step S104, when a determination result that the difference calculated in Step S103 has not exceeded the threshold is obtained (No in Step S104), the imaging apparatus 100 does not increment the value of the scene transition amount 14, and advances the procedure to the process of Step S106 described above.

After that, the imaging apparatus 100 determines whether processes on all the video difference frames 13 to be processed have been completed (Step S107). For example, when digital images are acquired at 30 fps from the encoding unit 108b, the imaging apparatus 100 determines whether processes on the digital images corresponding to the thirty frames have been completed.

When a determination result that the processes on all the video difference frames 13 to be processed have been completed is obtained (Yes in Step S107), the imaging apparatus 100 ends the flow shown in FIG. 7. In contrast, when a determination result that the processes on all the video difference frames 13 to be processed have not been completed is obtained (No in Step S107), the imaging apparatus 100 returns the procedure to the process of Step S101 described above.

In the process of Step S101 described above, when a determination result that the latest video difference frame 13 has not been acquired is obtained (No in Step S101), the imaging apparatus 100 advances the procedure to the process of Step S107 described above.

### Event Detection Process (First Embodiment)

Next, with reference to FIG. 8 and FIG. 9, the flow of the event detection process that is executed in the information processing apparatus 200 is described. The event detection process shown in FIG. 8 and FIG. 9 is carried out when the CPU 221 executes the event detection program 222a.

As shown in FIG. 8, the information processing apparatus 200 determines whether the verification data item 222e has been received (Step S201).

When a determination result that the verification data item 222e has been received is obtained (Yes in Step S201), the information processing apparatus 200 acquires the scene-transition-amount offset value 300a (Step S202).

Then, the information processing apparatus 200 subtracts the scene-transition-amount offset value 300a from the value of the scene transition amount 14 contained in the verification data item 222e (Step S203). Next, the information processing apparatus 200 determines whether a result of the subtraction in Step S203 is 1 or more (Step S204).

When a determination result that the result of the subtraction is 1 or more is obtained (Yes in Step S204), the information processing apparatus 200 determines that an abnormality has been detected in a monitoring site, and sends an email (Step S205) to the registered administrator (user terminal 400). Subsequently, the information processing apparatus 200 transmits an instruction to the imaging apparatus 100 (Step S206) such that the recorded data item of a corresponding time (time contained in the profile 11 of the verification data item 222e) is transmitted. The information processing apparatus 100 determines whether the recorded data item has been received (Step S207).

When a determination result that the recorded data item has not been received is obtained (No in Step S207), the information processing apparatus 200 waits until the recorded data item is received, and repeats the determination in Step S207.

Meanwhile, when a determination result that the recorded data item has been received is obtained (Yes in Step S207), the information processing apparatus 200 causes the received recorded data item to be stored into the external storage apparatus 300 (Step S208), and ends the event detection process.

In Step S204, when a determination result that the result of the subtraction is not 1 or more is obtained (No in Step S204), the information processing apparatus 200 acquires the motion-sensor offset value 300b (Step S209).

Then, the information processing apparatus 200 subtracts the motion-sensor offset value 300b from a value of the motion-sensor data item 15 contained in the verification data item 222e (Step S210). Next, the information processing apparatus 200 determines whether a result of the subtraction in Step S210 is 1 or more (Step S211).

When a determination result that the result of the subtraction is 1 or more is obtained (Yes in Step S211), the information processing apparatus 200 advances the procedure to the process of Step S205 described above. In contrast, when a determination result that the result of the subtraction is not 1 or more is obtained (No in Step S211), the information processing apparatus 200 acquires the sound-pressure-sensor offset value 300c (Step S212).

Then, the information processing apparatus 200 subtracts the sound-pressure-sensor offset value 300c from a value of the sound-pressure-sensor data item 16 contained in the verification data item 222e (Step S213). Next, the information processing apparatus 200 determines whether a result of the subtraction in Step S213 is 1 or more (Step S214).

When a determination result that the result of the subtraction is 1 or more is obtained (Yes in Step S214), the information processing apparatus 200 advances the procedure to the process of Step S205 described above. In contrast, when a determination result that the result of the subtraction is not 1 or more is obtained (No in Step S214), the information processing apparatus 200 ends the event detection process.

In Step S201, when a determination result that the verification data item 222e has not been received is obtained (No in Step S201), the information processing apparatus 200 ends the event detection process.

In the case described with reference to the example shown in FIG. 8, an email is sent to the registered administrator (Step S205). However, the process of sending the email need not necessarily be contained in the procedure. In the case described with reference to the example shown in FIG. 8 and FIG. 9, the processes are executed sequentially on the scene transition amount 14, the motion-sensor data item 15, and the sound-pressure-sensor data item 16. However, the order of the processes on the scene transition amount 14, the motion-sensor data item 15, and the sound-pressure-sensor data item 16 is not limited thereto, and may be changed.

[Offset-Value Update Process]

Next, with reference to FIG. 10, the flow of the offset-value update process that is executed in the information processing apparatus 200 is described. The offset-value update process shown in FIG. 10 is carried out when the CPU 221 executes the offset-value update program 222c.

As shown in FIG. 10, the information processing apparatus 200 determines whether to execute the updates of the offset values (Step S301). For example, the information processing apparatus 200 determines, based on the time recorded in the profile 11 of the verification data item 222e, whether to update currently-set offset values in accordance with a current time zone.

When the updates of the offset values are executed as a result of the determination (Yes in Step S301), the information processing apparatus 200 acquires the scene-transition-amount offset value 300a, the motion-sensor offset value 300b, and the sound-pressure-sensor offset value 300c (Step S302). Then, the information processing apparatus 200 acquires the offset-value update-reference data item 222d (Step S303).

Based on the offset-value update-reference data item 222d, the information processing apparatus 200 updates the scene-transition-amount offset value 300a, the motion-sensor offset value 300b, and the sound-pressure-sensor offset value 300c (Step S304).

Next, the information processing apparatus 200 determines whether to end the offset-value update process (Step S305).

When the offset-value update process is ended as a result of the determination (Yes in Step S305), the information processing apparatus 200 initializes the scene-transition-amount offset value 300a, the motion-sensor offset value 300b, and the sound-pressure-sensor offset value 300c (Step S306), and ends the offset-value update process. In contrast, when the offset-value update process is not ended as a result of the determination (No in Step S305), the information processing apparatus 200 returns the procedure to the process of Step S301 described above.

### Advantages of First Embodiment

As described hereinabove, in the first embodiment, when the abnormality in the monitoring site is detected, the information processing apparatus 200 transmits the instruction to the imaging apparatus 100 such that the recorded data item of the monitoring site is transmitted, and causes the recorded data item received from the imaging apparatus 100 to be stored into the external storage apparatus 300. In this way, according to the first embodiment, only the recorded data item in the case of the abnormality in the monitoring site can be recorded. As a result, a burden of running costs such as communication cost and management cost for the recorded data item of the monitoring site can be reduced as reliably as possible.

Further, in the first embodiment, when the abnormality in the monitoring site is detected based on at least one of the data items of the scene transition amount, the motion sensor, and the sound pressure sensor, the information processing apparatus 200 transmits the instruction to the imaging apparatus 100 such that the recorded data item of the monitoring site is transmitted. Thus, according to the first embodiment, in the case where a transition of a state occurs in the monitoring site, recorded data items can be stored as reliably as possible.

Further, in the first embodiment, the information processing apparatus 200 executes the process of detecting the abnormality in the monitoring site based on the values obtained by the subtractions of the corresponding offset values from the scene transition amount, the motion sensor, and the sound pressure sensor. Thus, according to the first embodiment, the transition of the state in the monitoring site can be detected with as high accuracy as possible.

### Second Embodiment

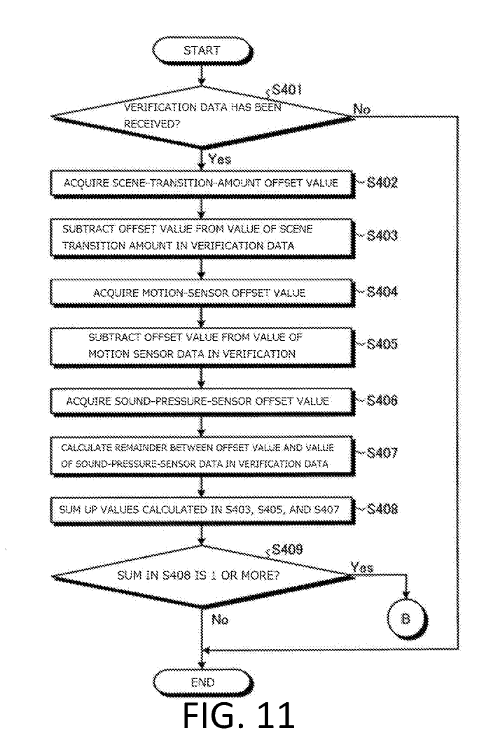

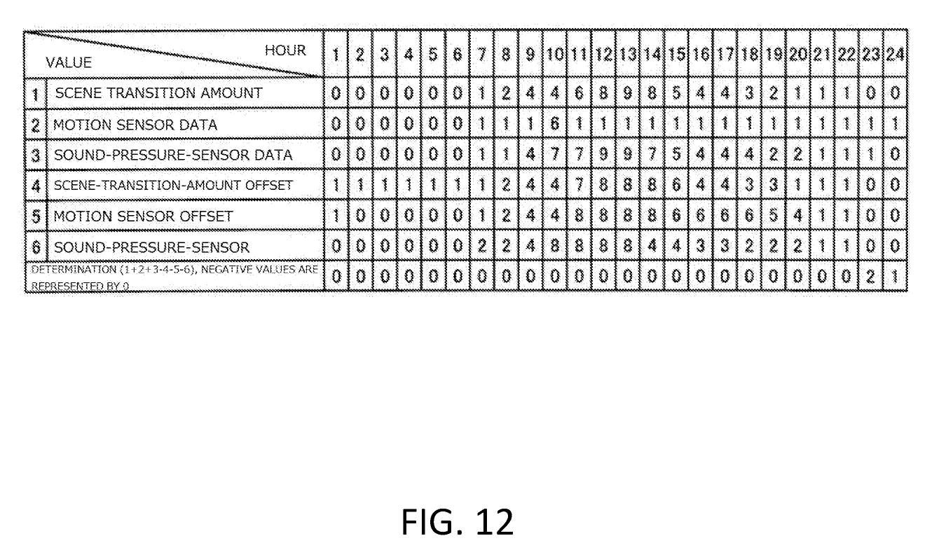

In the example described above in the first embodiment, when the abnormality in the monitoring site is detected based on the at least one of the data items of the scene transition amount, the motion sensor, and the sound pressure sensor, the instruction to transmit the recorded data item of the monitoring site is transmitted to the imaging apparatus 100. However, the present invention is not limited to this example. When the abnormality in the monitoring site is detected based on all the data items of the scene transition amount, the motion sensor, and the sound pressure sensor, the instruction to transmit the recorded data item of the monitoring site may be transmitted to the imaging apparatus 100. In a second embodiment described below, with reference to FIG. 11 and FIG. 12, processes according to the second embodiment are described. FIG. 11 is a flowchart showing a flow of an event detection process according to the second embodiment. FIG. 12 is a table showing an example of determination results of the event detection process according to the second embodiment.

### Event Detection Process (Second Embodiment)

As shown in FIG. 11, the information processing apparatus 200 determines whether the verification data item 222e has been received (Step S401).

When a determination result that the verification data item 222e has been received is obtained (Yes in Step S401), the information processing apparatus 200 acquires the scene-transition-amount offset value 300a (Step S402).

Then, the information processing apparatus 200 subtracts the scene-transition-amount offset value 300a from a value of the scene transition amount 14 contained in the verification data item 222e (Step S403). Next, the information processing apparatus 200 acquires the motion-sensor offset value 300b (Step S404), and subtracts the motion-sensor offset value 300b from a value of the motion-sensor data item 15 contained in the verification data item 222e (Step S405). After that, the information processing apparatus 200 acquires the sound-pressure-sensor offset value 300c (Step S406), and subtracts the sound-pressure-sensor offset value 300c from a value of the sound-pressure-sensor data item 16 contained in the verification data item 222e (Step S407).

Then, the information processing apparatus 200 sums up the values calculated in Step S403, Step S405, and Step S407 (Step S408).

Next, the information processing apparatus 200 determines whether a sum in Step S408 is 1 or more (Step S409).

When a determination result that the sum in Step S408 is 1 or more is obtained (Yes in Step S409), the information processing apparatus 200 advances the procedure to the process of Step S205 shown in FIG. 8. When the sum of the value obtained by the subtraction of the scene-transition-amount offset value 300a from the value of the scene transition amount 14, the value obtained by the subtraction of the motion-sensor offset value 300b from the value of the motion-sensor data item 15, and the value obtained by the subtraction of the sound-pressure-sensor offset value 300c from the value of the sound-pressure-sensor data item 16 exceeds 1, the information processing apparatus 200 generates a determination result that there is an abnormality in the monitoring site. FIG. 12 shows an example of correspondences between the values of the scene transition amounts 14, the motion-sensor data items 15, and the sound-pressure-sensor data items 16 corresponding to hours of from 1 o'clock to 24 o'clock, the scene-transition-amount offset values 300a, the motion-sensor offset values 300b, and the sound-pressure-sensor offset values 300c corresponding to those hours, and determination results corresponding to those hours. Specifically, the value “−2” is obtained by a subtraction of the scene-transition-amount offset value 300a, the motion-sensor offset value 300b, and the sound-pressure-sensor offset value 300c corresponding to 1 o'clock from the sum of the values of the scene transition amount 14, the motion-sensor data item 15, and the sound-pressure-sensor data item 16 corresponding to 1 o'clock. This value “−2” is normalized to “0,” and hence does not exceed “1.” Thus, a determination result that there is no abnormality in the monitoring site is generated. Meanwhile, the value “2” is obtained by a subtraction of the scene-transition-amount offset value 300a, the motion-sensor offset value 300b, and the sound-pressure-sensor offset value 300c corresponding to 23 o'clock from the sum of the values of the scene transition amount 14, the motion-sensor data item 15, and the sound-pressure-sensor data item 16 corresponding to 23 o'clock. This value “2” exceeds “1.” Thus, the determination result that there is an abnormality in the monitoring site is generated. In the example shown in FIG. 12, as a result of the determinations, for example, the determination results that there are abnormalities in the monitoring site at “23 o'clock” and “24 o'clock” are generated.

When a determination result that the sum in Step S408 is not 1 or more is obtained (No in Step S409), the information processing apparatus 200 ends the event detection process.

In Step S401, when a determination result that the verification data item 222e has not been received is obtained (No in Step S401), the information processing apparatus 200 ends the event detection process.

### Advantages of Second Embodiment

As described hereinabove, in the second embodiment, when the abnormality in the monitoring site is detected based on all the data items of the scene transition amount, the motion sensor, and the sound pressure sensor, the information processing apparatus 200 transmits the instruction to the imaging apparatus 100 such that the recorded data item of the monitoring site is transmitted. With this, according to the second embodiment, the abnormality in the monitoring site can be detected more reliably than in the event detection process described in the first embodiment. As a result, the burden of the running costs such as the communication cost and the management cost for the recorded data item of the monitoring site can be further reduced.

In the embodiments described hereinabove, the information processing apparatus 200 may instruct the imaging apparatus 100 to transmit the recorded data item in response to a request received from the user terminal 400. Specifically, when the request for transmitting the recorded data item is received from the user terminal 400, the information processing apparatus 200 transmits the instruction to the imaging apparatus 100 such that the recorded data item corresponding to the transmission request is transmitted. When receiving the recorded data item from the user terminal 400, the information processing apparatus 200 causes the received recorded data item to be stored into the external storage apparatus 300, and sends a message to the user terminal 400 so as to notify that the recorded data item can be viewed.

Note that, the configurations of the above-described embodiments of the present invention can be arbitrarily changed without departing from the gist of the present invention. For example, the programs of the above-described embodiments may be separately executed by a plurality of modules, or maybe integrated with other programs. Further, the functions of the information processing apparatus 200 may be separately exerted by a plurality of apparatus as appropriate.

### REFERENCE SIGNS LIST

1 network

100 imaging apparatus

106 image pickup element

107 capture unit

108a to 108c encoding unit

109 time measurement device

110 input processing unit

111 motion sensor

112 sound pressure sensor

113 thermal sensor

114 communication unit

115 recording memory

120 control unit

121 CPU

122 program memory

200 information processing apparatus

210 communication unit

220 control unit

221 CPU

222 program memory

300 external storage apparatus

400 user terminal

1-5. (canceled)

6. A monitoring system comprising:
an imaging apparatus configured to acquire a recorded data item of a monitoring site;
an information processing apparatus configured to control recording of the recorded data item; and
an external storage apparatus configured to store the recorded data item,
the imaging apparatus including:
a first sensor and a second sensor each configured to detect a non-physical quantity in the monitoring site;
a calculation unit configured to calculate, through comparison between data sizes of frames of the recorded data item, an evaluation value corresponding to variation between the data sizes;
a data storing unit configured to correlate to each other
the recorded data item,
a profile of the recorded data item,
the evaluation value corresponding to the recorded data item,
a value detected by the first sensor and corresponding to the recorded data item, and
a value detected by the second sensor and corresponding to the recorded data item,
the data storing unit being configured to cause the recorded data item, the profile, the evaluation value, the value detected by the first sensor, and the value detected by the second sensor to be stored into a storage unit;
a verification-data transmission unit configured to transmit a verification data item to the information processing apparatus, the verification data item being obtained by extracting, out of the recorded data item, the profile, the evaluation value, the value detected by the first sensor, and the value detected by the second sensor; and
a recorded-data transmission unit configured to acquire, when an instruction to transmit the recorded data item is received from the information processing apparatus, the recorded data item from the storage unit based on the profile contained in the instruction to transmit the recorded data item,
the recorded-data transmission unit being configured to transmit the acquired recorded data item to the information processing apparatus,
the information processing apparatus including:
an event detection unit configured to execute detection of an abnormality in the monitoring site based on:
a result of comparison between the evaluation value contained in the verification data item received from the imaging apparatus and a threshold,
a result of comparison between the value detected by the first sensor and a threshold, the value detected by the first sensor being contained in the verification data item, and
a result of comparison between the value detected by the second sensor and a threshold, the value detected by the second sensor being contained in the verification data item; and
a recorded-data storing unit configured to cause the recorded data item received from the imaging apparatus to be stored into the external storage apparatus,
the event detection unit being configured to transmit, to the imaging apparatus, the instruction to transmit the recorded data item based on the profile when the abnormality in the monitoring site is detected.

7. The monitoring system according to claim 6, wherein the event detection unit
executes the detection of the abnormality in the monitoring site based on the result of the comparison between the evaluation value contained in the verification data item received from the imaging apparatus and the threshold,
subsequently executes, when the abnormality in the monitoring site is not detected based on the result of the comparison between the evaluation value and the threshold, the detection of the abnormality in the monitoring site based on the result of the comparison between the value detected by the first sensor and the threshold, the value detected by the first sensor being contained in the verification data item, and
subsequently executes, when the abnormality in the monitoring site is not detected based on the result of the comparison between the value detected by the first sensor and the threshold, the detection of the abnormality in the monitoring site based on the result of the comparison between the value detected by the second sensor and the threshold, the value detected by the second sensor being contained in the verification data item.

8. The monitoring system according to claim 6, wherein the event detection unit executes all the comparison between the evaluation value and the threshold, the comparison between the value detected by the first sensor and the threshold, and the comparison between the value detected by the second sensor and the threshold, and executes the detection of the abnormality in the monitoring site based on all the results of the comparisons.

9. The monitoring system according to claim 7, wherein the external storage apparatus stores
an offset value corresponding to the evaluation value,
an offset value corresponding to the value detected by the first sensor, and
an offset value corresponding to the value detected by the second sensor, and
wherein the event detection unit
acquires, from the external storage apparatus,
the offset value corresponding to the value detected by the first sensor, and
the offset value corresponding to the value detected by the second sensor,
then subtracts the corresponding offset values respectively from the evaluation value, the value detected by the first sensor, and the value detected by the second sensor, and
then executes a comparison with a threshold.

10. A monitoring method that is executed by a monitoring system comprising:
an imaging apparatus configured to acquire a recorded data item of a monitoring site;
an information processing apparatus configured to control recording of the recorded data item; and
an external storage apparatus configured to store the recorded data item,
the monitoring method comprising causing the imaging apparatus to carry out:
a step of detecting a non-physical quantity in the monitoring site;
a step of calculating, through comparison between data sizes of frames of the recorded data item, an evaluation value corresponding to variation between the data sizes;
a step of correlating to each other
the recorded data item,
a profile of the recorded data item,
the evaluation value corresponding to the recorded data item,
a value detected by the first sensor and corresponding to the recorded data item, and
a value detected by the second sensor and corresponding to the recorded data item,
and of causing the recorded data item, the profile, the evaluation value, the value detected by the first sensor, and the value detected by the second sensor to be stored into a storage unit;
a step of transmitting a verification data item to the information processing apparatus, the verification data item being obtained by extracting, out of the recorded data item, the profile, the evaluation value, the value detected by the first sensor, and the value detected by the second sensor; and
a step of acquiring, when an instruction to transmit the recorded data item is received from the information processing apparatus, the recorded data item from the storage unit based on the profile contained in the instruction to transmit the recorded data item,
and of transmitting the acquired recorded data item to the information processing apparatus,
the monitoring method comprising causing the information processing apparatus to carry out:
a step of executing detection of an abnormality in the monitoring site based on
a result of comparison between the evaluation value contained in the verification data item received from the imaging apparatus and a threshold,
a result of comparison between the value detected by the first sensor and a threshold, the value detected by the first sensor being contained in the verification data item, and
a result of comparison between the value detected by the second sensor and a threshold, the value detected by the second sensor being contained in the verification data item;
a step of transmitting, to the imaging apparatus, the instruction to transmit the recorded data item based on the profile when the abnormality in the monitoring site is detected; and
a step of causing the recorded data item received from the imaging apparatus to be stored into the external storage apparatus.
